(19) United States
(12) Patent Application Publication
(10) Pub. No.: US 2001/0021047 A1
(43) Pub. Date: Sep. 13, 2001

(54) Optical transmission system and optical receiver

(76) Inventors: Hiroyuki Sasai, Katano (JP); Masaru Fuse, Toyonaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/740,813

(22) Filed: Dec. 21, 2000

(30) Foreign Application Priority Data
Dec. 24, 1999 (JP) 366726/1999

(51) Int. Cl. H04J 14/02; H04B 10/12

(52) U.S. Cl. 359/124; 359/173

(57) ABSTRACT

ASK modulation parts 111 to 11n receive digital data 11 to 1n, respectively, for ASK modulation and then multiplexing. The resultant signal obtained thereby is used to SSB modulate light coming from a light source 130. An optical filter part 550 receives an optical signal obtained through SSB modulation, and from the signal, an optical carrier component and an optical sideband component are extracted. The optical sideband component is then SSB modulated again this time by a local oscillation signal equal in carrier frequency to any one digital data desired among those 11 to 1n, and then combined with the optical carrier component. Thus obtained optical signal is converted, by square detection, in an optical-electrical conversion part 370 into an electrical signal. This electrical signal is the desired one which has been demultiplexed through the system.

### BACKGROUND OF THE INVENTION

1. Field of the Invention

The present invention relates to optical transmission systems and optical receivers and, more specifically, to an optical transmission system which transmits a plurality of electrical signals after frequency division multiplexing, and an optical receiver suitably used for such system.

2. Description of the Background Art

FIG. 8 shows the structure of a conventional optical transmission system which transmits a plurality of electrical signals under the frequency division multiplexing technology.

In FIG. 8, the optical transmission system is provided with a plurality of digital modulation parts 811 to 81n, frequency division multiplex part 120, light source 130, intensity modulation part 140, optical fiber 150, optical-electrical conversion part 870, frequency selection part 880, and digital demodulation part 890.

Described next below is the operation of such conventional optical transmission system.

The digital modulation parts 811 to 81n receive to-be-transmitted digital data 11 to 1n, respectively. The digital modulation parts 811 to 81n then each modulate carriers varied in frequency with the corresponding digital data 11 to 1n, and output a digital modulated signal. The frequency division multiplex part 120 multiplexes the digital modulated signal outputted from each of the digital modulation parts 811 to 81n, and outputs a frequency division multiplex signal. The light source 130 outputs light, and the light goes to the intensity modulation part 140 to be modulated in intensity by the frequency division multiplex signal. The resultant optical signal is transmitted through the optical fiber 150, and then converted into an electrical signal in the optical-electrical conversion part 870. The electrical signal is a signal on which the digital modulated signals are multiplexed. Thereafter, selected from this signal in the frequency selection part 880 is one of the digital modulated signals carrying any one digital data desired among the digital data 11 to 1n. By demodulating such selected digital modulated signal in the digital demodulation part 890, the desired digital data is derived.

To derive the desired digital data in the above conventional optical transmission system, however, there needs to provide the frequency selection part 880 with every digital modulated signal. As a result, the optical-electrical conversion part 870 and electrical devices subsequent thereto including the frequency selection part 880, an amplifier (not shown), and the like, are characteristically required to be broadband to cover not only the band of one digital modulated signal but that of the entire frequency division multiplex signal. If the digital modulated signals are increased in number for the purpose of increasing transmission capacity, the band of the frequency division multiplex signal resultantly becomes broader. Therefore, to deal with such broader bandwidth, the whole system including those electric devices ends in higher cost.

### SUMMARY OF THE INVENTION

Therefore, an object of the present invention is to provide an optical transmission system capable of transmitting a frequency division multiplex signal over a broader frequency band without needing any electrical broadband device on the receiver side, and accordingly increasing optical transmission capacity while reducing cost increase.

In order to attain the object above, an optical transmission system of the present invention comprises:

a plurality of amplitude modulation parts for receiving each corresponding transmitting data, and amplitude-modulating carriers of differing frequencies by the transmitting data;

a frequency division multiplex part for receiving a resultant amplitude modulated signal from each of the amplitude modulation parts, and multiplexing the amplitude modulated signals and outputting a frequency division multiplex signal;

an intensity modulation part for intensity modulating an optical signal by the frequency division multiplex signal, and outputting the intensity-modulated optical signal to the optical transmission path;

an external modulation part for intensity modulating the intensity-modulated optical signal this time by an electrical signal equal in frequency to any one of the carriers used in the plurality of amplitude modulation parts; and

an optical-electrical conversion part for converting, by square detection, the optical signal provided by the external modulation part into an electrical signal.

As is known from the above, according to the present invention, an incoming optical signal is modulated in intensity twice, once on the transmission side by a frequency division multiplex signal, and again on the reception side by an electrical signal of frequency corresponding to any desired data. Accordingly, outputted from an optical-electrical conversion part is the desired electrical signal which has been demultiplexed. Therefore, there is no need for electrical devices to cover the entire bandwidth of a frequency division multiplex signal. With such structure, no expensive broadband electrical device is required, and signals can be allocated over a broader frequency band with which an optical device can deal, and accordingly the optical transmission capacity is increased while reducing cost increase.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of an optical transmission system according to a first embodiment of the present invention;

FIG. 2 is a block diagram showing the structure of an optical transmission system of a second embodiment;

FIG. 3 is a block diagram showing the structure of an optical transmission system of a third embodiment;

FIGS. 4a to 4c are exemplary spectra of, respectively, an optical signal at time of coming into an optical filter, coming out of a second SSB modulation part, and coming out of an optical combiner;

FIG. 5 is a block diagram showing the structure of an optical transmission system of a fourth embodiment;

FIG. 6 is a diagram showing the structure of an optical transmission system of a fifth embodiment;

FIGS. 7a and 7b are exemplary spectra of, respectively, at time of an optical signal coming into a fixed optical filter, and coming out of an optical combiner; and

FIG. 8 is a block diagram showing the structure of a conventional optical transmission system.

### DESCRIPTION OF THE PREFERRED EMBODIMENTS

(First Embodiment)

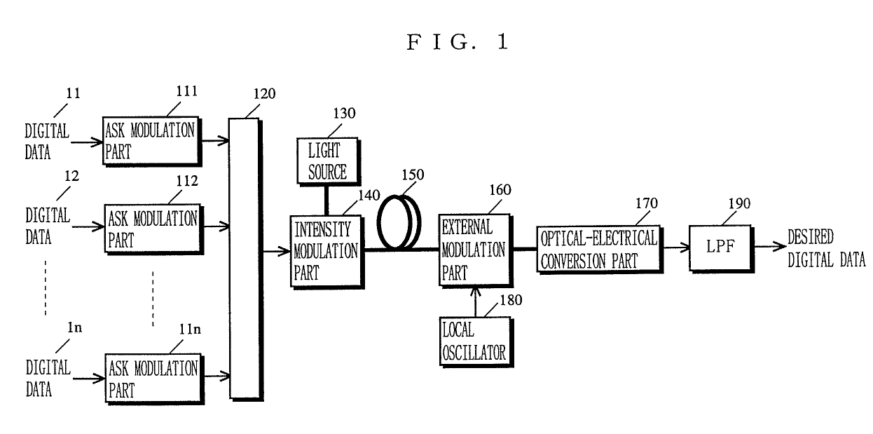

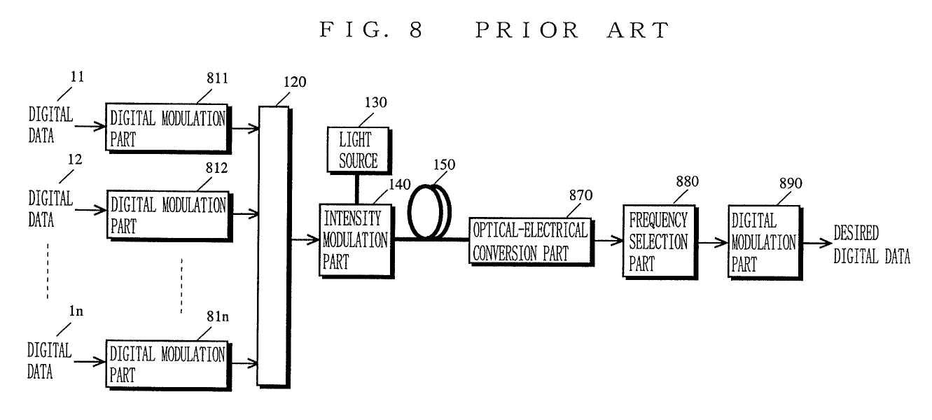

FIG. 1 is a block diagram showing the structure of an optical transmission system according to a first embodiment of the present invention. In FIG. 1, the optical system is provided with a plurality of ASK (Amplitude Shift Keying) modulation parts 111 to 11n, the frequency division multiplex part 120, the light source 130, the intensity modulation part 140, the optical fiber 150, an external modulation part 160, an optical-electrical conversion part 170, a local oscillator 180, and an LPF (low-pass filter) 190. Here, any constituent identical to that in FIG. 8 is under the same reference numeral.

Described below is the operation of the optical transmission system of the first embodiment.

The to-be-transmitted digital data 11 to 1n is in binary, and is provided to a plurality of ASK modulation parts 111 to 11n, respectively. The ASK modulation parts 111 to 11n each subject, to ASK modulation, carriers varied in frequency from f_{1 to f}ₙ by the corresponding digital data 11 to 1n, and then output an ASK signal. Thus outputted n ASK signals are multiplexed by the frequency division multiplex part 120, and a frequency division multiplex signal is outputted. The light source 130 outputs light constant in intensity. The light goes to the intensity modulation part 140, and is modulated in intensity by the frequency division multiplex signal therein. The resultant optical signal is transmitted through the optical fiber 150. The local oscillator 180 outputs a local oscillation signal whose frequency is equal to the carrier frequency of any one ASK signal carrying the desired digital data. The external modulation part 160 modulates, in intensity, the optical signal again this time by the local oscillation signal provided by the local oscillator 180. The resultant optical signal is then converted, by square detection, into an electrical signal in the optical-electrical conversion part 170. From the electrical signal, the LPF 190 extracts any band component corresponding to the desired digital data.

With reference to the following equations, described next is the principle of the desired digital data being extracted through the above-described operation.

The intensity modulation part 140 receives light constant in intensity from the light source 130, and modulates the light by a frequency division multiplex signal on which n ASK signals of differing carrier frequencies from f1 to fn are multiplexed. Here, assuming that the intensity of the resultant optical signal is P₁, P₁ is expressed by the following equation (1):

$${P}_{1} = [ 1 + OMI {\sum }_{m = 1}^{n} \{ {S}_{m} ( t ) cos ( 2 π {f}_{m} t ) \} ] {P}_{0} \qquad ( 1 )$$

In the equation (1), P₀ denotes the intensity of the optical signal when no modulation is performed, OMI denotes the optical modulation index for the ASK signals multiplexed on the frequency division multiplex signal, and Sₘ(t) denotes the level in binary (“1” or “0”) of the mth digital data 1m.

With respect to the intensity-modulated optical signal, the external modulation part 160 performs frequency conversion by modulating the optical signal in intensity again this time by a local oscillation signal having frequency of fₖ (where k is an arbitrary integer from 1 to n). Here, assuming that the intensity of the resultant optical signal is P₂, P₂ is expressed by the following equation (2):

$${P}_{2} = L \{ 1 + cos ( 2 π {f}_{k} t ) \} [ 1 + OMI {\sum }_{m = 1}^{n} \{ {S}_{m} ( t ) cos ( 2 π {f}_{m} t ) \} ] {P}_{0} \qquad ( 2 )$$

In the equation (2), L denotes any influence caused by an optical loss occurred in the optical fiber 150 and the external modulation part 160, and the like. The equation (2) is expanded to be the following equation (3):

$${P}_{2} = L [ 1 + cos ( 2 π {f}_{k} t ) + OMI {\sum }_{m = 1}^{n} \{ {S}_{m} ( t ) cos ( 2 π {f}_{m} t ) \} + OMI cos ( 2 π {f}_{k} t ) {\sum }_{m = 1}^{n} \{ {S}_{m} ( t ) cos ( 2 π {f}_{m} t ) \} ] {P}_{0} \qquad ( 3 )$$

The optical signal having the intensity expressed by the The optical signal having the intensity expressed by the equation (3) is provided to the optical-electrical conversion part 170, and then is converted into an electrical signal by square detection. Here, assuming that η denotes the conversion efficiency at time of optical-electrical conversion, a current i to be outputted from the optical-electrical conversion part 170 is expressed by the following equation (4):

$$i = η {LP}_{0} [ 1 + \frac{OMI}{2} \cdot {S}_{k} k ( t ) + \frac{OMI}{2} {\sum }_{m \neq k} {S}_{k} ( t ) cos \{ 2 π ( {f}_{m} - {f}_{k} ) t \} + ⃛ ] \qquad ( 4 )$$

In the equation (4), the second term, if expanded, denotes digital data carried by the ASK signal whose carrier frequency is fₖ. It is thus known from the equation (4) that such digital data has been demodulated before outputted from the optical-electrical conversion part 170. Accordingly, unlike the conventional optical transmission system of FIG. 8, there is no need for electrical devices for selecting and demodulating any one ASK signal.

In the equation (4), the third term and thereafter, if expanded, are regarded as being unwanted high frequency components outputted from the optical-electrical conversion part 170. In this embodiment, the LPF 190 is the one used to exclude such unwanted high frequency components. Herein, if devices such as the optical-electrical conversion part 170 and an amplifier subsequent thereto, which is provided as required, are characteristically capable of passing only any low frequency component, the LPF 190 may be omitted.

In this embodiment, the to-be-transmitted data is in binary. This is not restrictive, and the data may be multilevel or analog. If analog, there needs to use an analog amplitude modulator instead of the ASK modulation parts 111 to 11n.

Further, although the light coming from the light source 130 is presumed to be externally modulated by the frequency division multiplex signal in the intensity modulation part 140, the light may be modulated directly by the frequency division multiplex signal.

The external modulation part 160 may be implemented by a general type of external optical modulator, or a semiconductor optical amplifier. The semiconductor optical amplifier is capable of optical-amplifying in addition to intensity-modulating, therefore can prevent the optical signal from decreasing in power due to optical loss at time of frequency selection. Accordingly, it is possible to increase the transmission distance.

Further, the well-known wavelength division multiplexing technology may also be applied to the optical transmission system of this embodiment. If applied, a plurality of optical transmission parts and optical reception parts are provided. Here, the optical transmission parts each include the ASK modulation parts 111 to 11n, the frequency division multiplex part 120, the light source 130, the intensity modulation part 140, all of which are the ones appeared in the first embodiment. Similarly, the optical reception parts each include the external modulation part 160, the optical-electrical conversion part 170, the local oscillator 180, and the LPF 190. Optical signals varied in wavelength each transmitted from the optical transmission parts are multiplexed and then transmitted via the optical fiber, and demultiplexed based on the optical frequency. Thus demultiplexed optical signals are then supplied to each corresponding optical reception part, and subjected to frequency selection before being converted into electrical signals. As such, with the help of the wavelength division multiplexing technology, optical transmission capacity can be increased.

As is known from the above, according to the first embodiment, an incoming optical signal which has already been modulated is modulated in intensity again by a local oscillation signal from the local oscillator 180. Thus, no digital demodulation part is needed for demodulating any one ASK signal of desired frequency selected from a frequency division multiplex signal, whereby the cost increase is reduced. Moreover, in the conventional optical transmission system, such digital demodulation part provided subsequent to the optical-electrical conversion part 870 is required to cover the entire bandwidth of the frequency division multiplex signal. On the other hand, in the present optical transmission system, such electrical device as amplifier appropriately provided subsequent to the optical-electrical conversion part 170 only needs to cover the bandwidth of one ASK signal. This is because the signal processed therein is an electrical signal already having selected with the desired ASK signal. Accordingly, without such broadband digital demodulation part, optical transmission capacity can be increased no matter how many ASK signals are subjected to frequency division multiplexing. With such structure, broadband optical devices are effectively utilized to increase the optical transmission capacity.

(Second Embodiment)

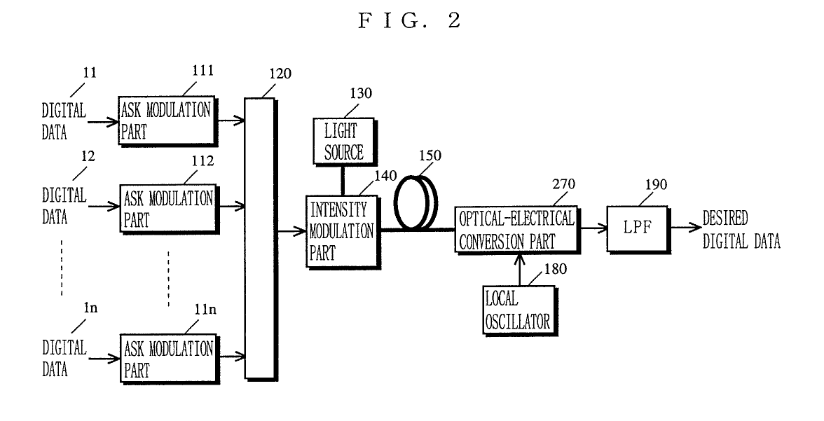

FIG. 2 is a block diagram showing the structure of an optical transmission system according to a second embodiment. In FIG. 2, the optical transmission system is provided with a plurality of ASK modulation parts 111 to 11n, the frequency division multiplex part 120, the light source 130, the intensity modulation part 140, the optical fiber 150, an optical-electrical conversion part 270, the local oscillator 180, and the LPF 190. Here, any constituent identical to that in FIG. 1 is under the same reference numeral.

Described below is the operation of the optical transmission system of the second embodiment, focusing on the operation from the stage of optical fiber 150 and thereafter as is the only difference from the system of the first embodiment.

The optical signal from the intensity modulation part 140 goes through the optical fiber 150 and reaches the optical-electrical conversion part 270. The local oscillator 180 outputs a local oscillation signal whose frequency is equal to the carrier frequency of any one ASK signal carrying any desired digital data. The local oscillation signal is superposed on a bias voltage or a bias current of the optical-electrical conversion part 270. The optical-electrical conversion part 270 converts the optical signal into an electrical signal by square detection so as to mix the optical signal with the local oscillation signal superposed this time on the bias voltage so as to perform frequency conversion. As a result, outputted from the optical-electrical conversion part 270 is the desired digital data which has been demodulated as in the first embodiment. Therefore, there is no need to have the digital demodulation part for selecting and demodulating any one ASK signal.

Thereafter, similar to the first embodiment, the LPF 190 extracts only the desired digital data from the electrical signal converted by the optical-electrical conversion part 270. Herein, if the optical-electrical conversion part 270 and electrical devices such as an amplifier appropriately provided subsequent to the optical-electrical conversion part 270 is characteristically capable of passing only any low frequency component, the LPF 190 may be omitted.

Also, similar to the first embodiment, the data to be transmitted is not limited to be in binary, and the light coming from the light source 130 may be directly modulated by a frequency division multiplex signal.

As is known from the above, according to the second embodiment, frequency selection can be simultaneously performed with optical-electrical conversion by superposing a local oscillation signal on a bias voltage of an optical-electrical conversion part. Here, the frequency of the local oscillation signal is equal to a carrier frequency of an ASK signal carrying the desired digital data. This is the reason why no digital demodulation part is required to select any one ASK signal of the desired frequency from the frequency division multiplexing signal for demodulation. Furthermore, any other device does not have to be characteristically broadband to cover the entire frequency division multiplex signal. Accordingly, optical transmission capacity can be increased while reducing cost increase.

(Third Embodiment)

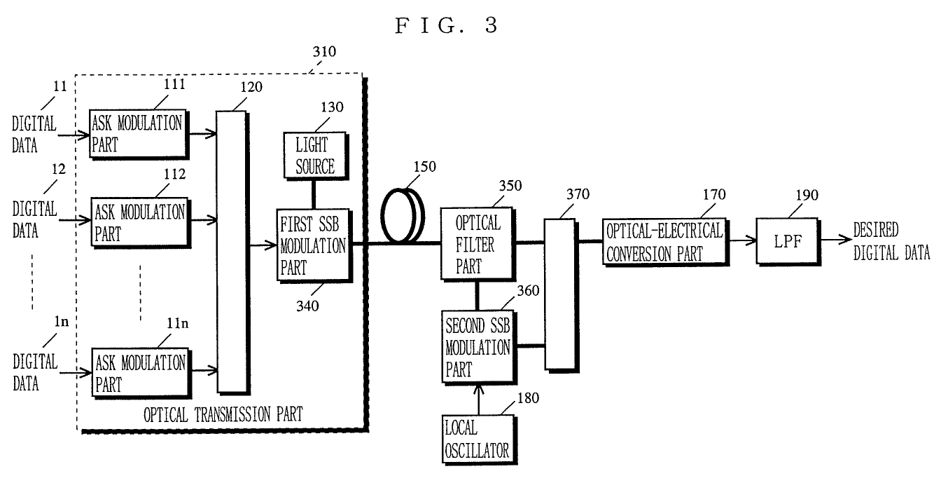

FIG. 3 is a block diagram showing the structure of an optical transmission system of a third embodiment. In FIG. 3, the optical transmission system is provided with an optical transmission part 310, the optical fiber 150, an optical filter part 350, a second SSB (Single SideBand) modulation part 360, an optical combiner 370, the optical-electrical conversion part 170, the local oscillator 180, and the LPF 190. Herein, the optical transmission part 310 includes a plurality of ASK modulation parts 111 to 11n, the frequency division multiplex part 120, a first SSB modulation part 340, and the light source 130. In FIG. 3, any constituent identical to that in FIG. 1 is under the same reference numeral.

Described below is the operation of the optical transmission system of the third embodiment.

The ASK modulation parts 111 to 11n receive to-be-transmitted digital data 11 to 1n, respectively. The ASK modulation parts 111 to 11n each subject, to ASK modulation, carriers varied in frequency from f1 to fn by the corresponding digital data 11 to 1n, and then output an ASK signal. Thus outputted n ASK signals are multiplexed by the frequency division multiplex part 120, and a frequency division multiplex signal is outputted. The light source 130 outputs light, and the light goes to the first SSB modulation part 340 to be subjected to SSB modulation by the frequency division multiplex signal therein. The SSB modulation herein denotes such modulation scheme as making a signal spectrum after modulation include an optical carrier component and either an upper or lower sideband component. The resultant optical signal coming from the first SSB modulation part 340 is transmitted to the optical filter part 350 through the optical fiber 150.

From the optical signal, two types of components of optical carrier and optical sideband are extracted. Here, an optical sideband component of the optical signal includes a plurality of components, each of which carries an ASK signal. The optical carrier component goes to the optical combiner 370, while the optical sideband component goes to the second SSB modulation part 360. The local oscillator 180 outputs a local oscillation signal whose frequency is equal to the carrier frequency of any one ASK signal carrying any desired digital data. By the local oscillation signal, the second SSB modulation part 360 subjects the received optical sideband component to SSB modulation. If the first SSB modulation part 340 has performed SSB modulation in such manner as to generate an upper sideband, SSB modulation herein is so performed as to generate a lower sideband, and vice versa.

The optical combiner 370 combines thus received optical carrier component and the SSB-modulated optical sideband component. The resultant optical signal is provided to the optical-electrical conversion part 170, and then converted into an electrical signal by square detection. Thereafter, from the electrical signal, the LPF 190 extracts any band component including the desired digital data.

With reference to the accompanying drawings, described next is the principle of the desired digital data being extracted through the above-described operation.

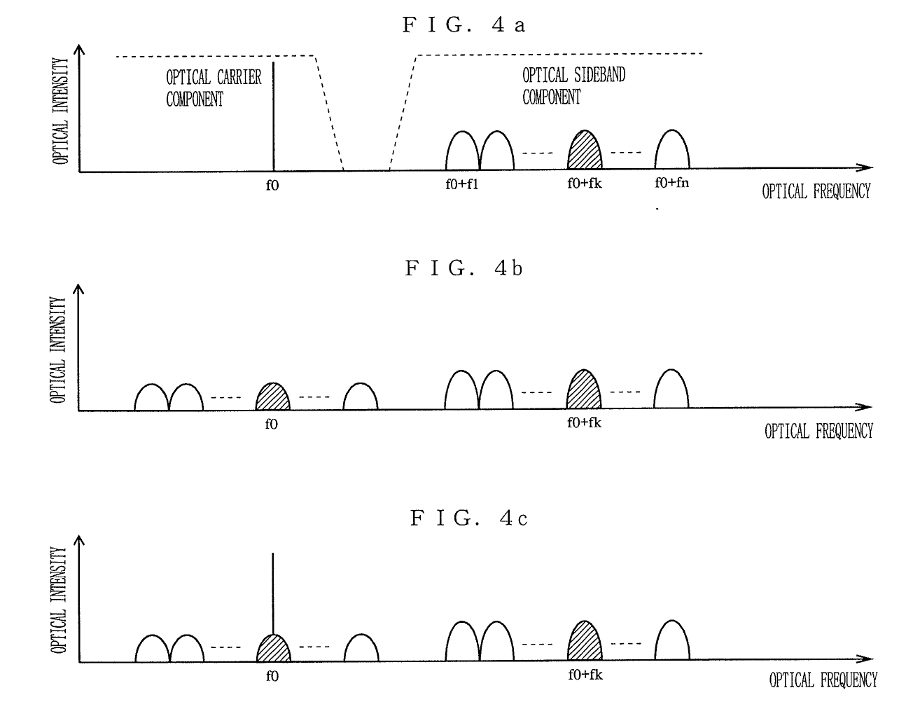

FIG. 4a is an exemplary spectrum of an optical signal at time of coming into the optical filer part 350. Here, presumably, the ASK signals multiplexed on the frequency division multiplex signal are varied in carrier frequency from f1 to fn, any one ASK signal carrying the desired digital data has carrier frequency of fk, and the light coming from the light source 130 has optical frequency of f0. Moreover, the first SSB modulation part 340 presumably carries out SSB modulation in such manner as to generate an upper sideband. The resultant optical signal obtained thereby goes to the optical filter part 350, and therefrom, two types of components of optical carrier and optical sideband are extracted. In FIG. 4a, two dotted broken lines both show the exemplary transmittance of the optical filter part 350 used for the extraction.

Out of the optical signal, the extracted optical sideband component goes to the second SSB modulation part 360 to be SSB modulated again this time by a local oscillation signal of frequency fk coming from the local oscillator 180. FIG. 4b is an exemplary spectrum of the resultant optical signal coming out of the second SSB modulation part 360. Since the second SSB modulation part 360 so performs SSB modulation as to generate a lower sideband, as shown in FIG. 4b, the optical sideband component is down converted by the frequency fk. Accordingly, a shaded area in the drawing which denotes an optical component (optical frequency f0+fk) corresponding to the ASK modulated signal of carrier frequency fk is frequency-converted and comes to the position of optical frequency f0.

The optical combiner 370 combines the optical carrier component shown in FIG. 4a with the optical sideband component provided by the second SSB modulation part 360 in FIG. 4b for output to the optical-electrical conversion part 170. FIG. 4c is an exemplary spectrum of the resultant optical signal coming out of the optical combiner 370. In the spectrum, at the optical frequency f0, the optical carrier component is overlaid on the optical component corresponding to the ASK modulated signal of carrier frequency fk. Therefore, by converting this optical signal by square detection in the optical-electrical conversion part 170 into an electrical signal, the desired digital data can be obtained in the baseband.

Note herein that, from the optical filter part 350, the optical carrier component is provided to the optical combiner 370, and the optical sideband component to the second SSB modulation part 360. This is not restrictive, and similarly the desired digital data can be derived if the optical carrier component goes to the second SSB modulation part 360, and the optical sideband component to the optical combiner 370. In such case, the second SSB modulation part 360 needs to perform SSB modulation in such manner as to generate the optical sideband component on the same side as in the first SSB modulation part 340. As an example, if the first SSB modulation part 340 has generated an upper sideband, the second SSB modulation part 360 follows suit.

Similar to the first embodiment, if electrical devices such as the optical-electrical conversion part 170 and an amplifier appropriately provided subsequent thereto are characteristically capable of passing only any low frequency component, the LPF 190 may be omitted.

Also, similar to the first embodiment, the data to be transmitted is not limited to be in binary.

As is known from the above, according to the third embodiment, frequency selection can be done to an optical signal by going through such steps as extracting, from an incoming optical signal, two types of components of optical carrier and optical sideband, SSB modulating thus obtained optical sideband component by a local oscillation signal whose frequency is equal to a carrier frequency of an ASK signal carrying the desired digital data, and then combining the SSB-modulated component with the optical carrier component. Accordingly, there is no need to include a digital demodulation part for selecting any one ASK signal of desired frequency from a frequency division multiplex signal for demodulation. Further, any other device is not required to be characteristically broadband to deal with the entire frequency division multiplex signal. Therefore, no matter what type of electrical devices, ASK signals can be allocated over a broader frequency band, and accordingly the optical transmission capacity is increased while reducing cost increase.

(Fourth Embodiment)

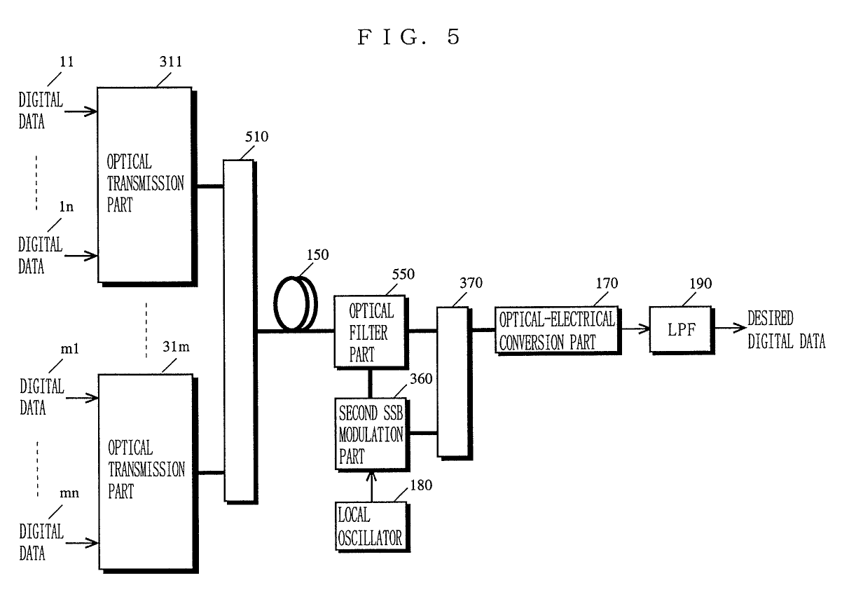

FIG. 5 is a block diagram showing the structure of an optical transmission system of a fourth embodiment. In FIG. 5, the optical transmission system is provided with a plurality of optical transmission parts 311 to 31m, an optical multiplex part 510, the optical fiber 150, an optical filter part 550, the second SSB modulation part 360, the optical combiner 370, the optical-electrical conversion part 170, the local oscillator 180, and the LPF 190. The optical transmission parts 311 to 31m are presumed to be in the same structure as the optical transmission part 310 in FIG. 3. Here, any constituent identical to the one in FIG. 5 is under the same reference numeral in FIG. 3.

Described next is the operation of the optical transmission part of the fourth embodiment.

The optical transmission parts 311 to 31m receive each corresponding set of digital data varying from 11-1n to m1-mn. The optical transmission parts 311 to 31m each subject, to SSB modulation, optical signals of differing optical frequencies by a frequency division multiplex signal. Here, on the frequency division multiplex signal, ASK signals each corresponding to the digital data are multiplexed. The resultant optical signals outputted from each of the optical transmission parts 311 to 31m are multiplexed by the optical multiplex part 510, and transmitted via the optical fiber 150.

From the transmitted optical signal, the optical filter part 550 extracts an optical carrier component and an optical sideband component of one optical signal multiplexed thereon. Herein, the optical filter part 550 may be implemented by a set including a 1×2 optical branching unit and two variable optical filters, for example. The optical carrier component goes to the optical combiner 370, while the optical sideband component to the second SSB modulation part 360. The local oscillator 180 outputs a local oscillation signal whose frequency is equal to the carrier frequency of any one ASK signal carrying the desired digital data. By the local oscillation signal, the second SSB modulation part 360 subjects the received optical sideband component to SSB modulation. Here, if first SSB modulation parts included in each of the optical transmission parts 311 to 31m have performed SSB modulation in such manner as to generate an upper sideband, SSB modulation herein is so performed as to generate a lower sideband, and vice versa. The optical combiner 370 combines the optical carrier component with the resultant optical signal outputted from the second SSB modulation part 360. The optical-electrical conversion part 170 converts, by square detection, the resultant optical signal into an electrical signal. From the electrical signal, the LPF 190 then extracts the desired digital data.

In the foregoing, the optical carrier component extracted in the optical filter part 550 first goes to the optical combiner 370, while the optical sideband component to the second SSB modulation part 360. This is not restrictive, and the optical carrier may goes to the second SSB modulation part 360, and the optical sideband component to the optical combiner 370. In such case, the second SSB modulation part 360 needs to perform SSB modulation in such manner as to generate the optical sideband component on the same side as in the first SSB modulation parts in the set of optical transmission parts 311 to 31m. As an example, if the first SSB modulation parts have generated an upper sideband, the second SSB modulation part 360 follows suit.

Herein, if the optical-electrical conversion part 270 and electrical devices such as an amplifier appropriately provided subsequent thereto is characteristically capable of passing only any low frequency component, the LPF 190 may be omitted.

Also, similar to the first embodiment, the data to be transmitted is not limited to be in binary.

As is known from the above, according to the fourth embodiment, frequency selection can be done to an optical signal by going through such steps as determining which optical signal multiplexed on an incoming optical signal carries any desired digital data, extracting two types of components of optical carrier and optical sideband from the determined optical signal, SSB modulating thus obtained optical sideband component by a local oscillation signal whose frequency is equal to a carrier frequency of an ASK signal carrying the desired digital data, and then combining the SSB-modulated optical signal with the optical carrier component. Accordingly, there is no need to include a digital demodulation part for selecting any one ASK signal of desired frequency from a frequency division multiplex signal for demodulation. Further, an optical-electrical conversion part and any device connected subsequent thereto are not required to be characteristically broadband. Therefore, signals can be allocated over a broader frequency band, and accordingly the optical transmission capacity is increased while reducing cost increase. Still further, compared with a DSB (Double SideBand) modulation scheme which makes a modulated signal include components of carrier and an upper and a lower sidebands, the SSB modulation scheme applied herein reduces the occupied bandwidth and accordingly the more signals can be subjected to frequency division multiplexing.

(Fifth Embodiment)

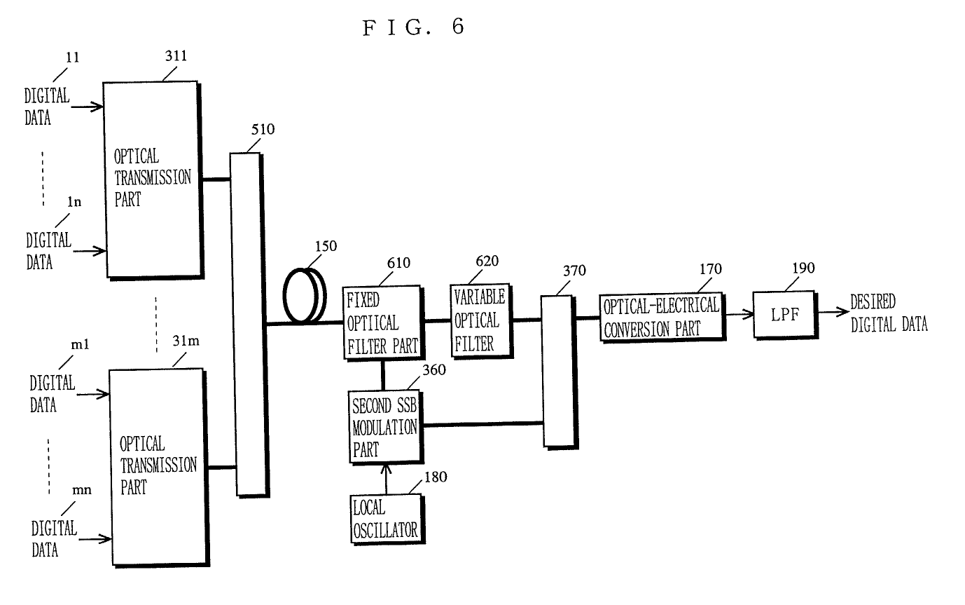

FIG. 6 is a block diagram showing the structure of an optical transmission system according to a fifth embodiment. In FIG. 6, the optical transmission system is provided with a plurality of optical transmission parts 311 to 31m, the optical multiplex part 510, the optical fiber 150, a fixed optical filter part 610, a variable optical filter 620, the second SSB modulation part 360, the local oscillator 180, the optical combiner 370, the optical-electrical conversion part 170, and the LPF 190. Herein, any constituent identical to that in FIG. 5 is under the same reference numeral.

Described below is the operation of the optical transmission system of the fifth embodiment, focusing only on the fixed optical filter part 610 and the variable filter 620, which are provided as alternatives to the optical filter part 550 in the fourth embodiment. This is the only difference from the system of the first embodiment.

The optical signal coming through the optical fiber 150 reaches the fixed optical filter part 610. The fixed optical filter part 610 includes a fixed filter whose transmittance shows periodicity to optical wavelength. The fixed optical filter part 610 extracts, from the optical signal coming from the optical fiber 150, a group of optical carrier components and a group of optical sideband components of every optical signal multiplexed thereon. Thus extracted group of optical carrier components go to the variable filter 620, and then any optical carrier component of desired wavelength is selected and extracted therefrom for output to the optical combiner 370. On the other hand, the group of optical sideband components go to the second SSB modulation part 360 to be SSB modulated by a local oscillation signal whose frequency is equal to the carrier frequency of any one ASK signal carrying the desired digital data. The SSB-modulated optical signal is then outputted to the optical combiner 370. Here, if first SSB modulation parts included in each of the optical transmission parts 311 to 31m have generated an upper sideband through SSB modulation, the second SSB modulation part 360 so performs SSB modulation as to generate a lower sideband, and vice versa. The optical combiner 370 combines the optical carrier component with the resultant optical signal outputted from the second SSB modulation part 360, and then the resultant optical signal goes to the optical-electrical conversion part 170 to be converted therein into an electrical signal by square detection. From the electrical signal, the LPF 190 extracts the desired digital data.

With reference to the accompanying drawings, described next is the principle of the desired digital data being demodulated through the above-described operation.

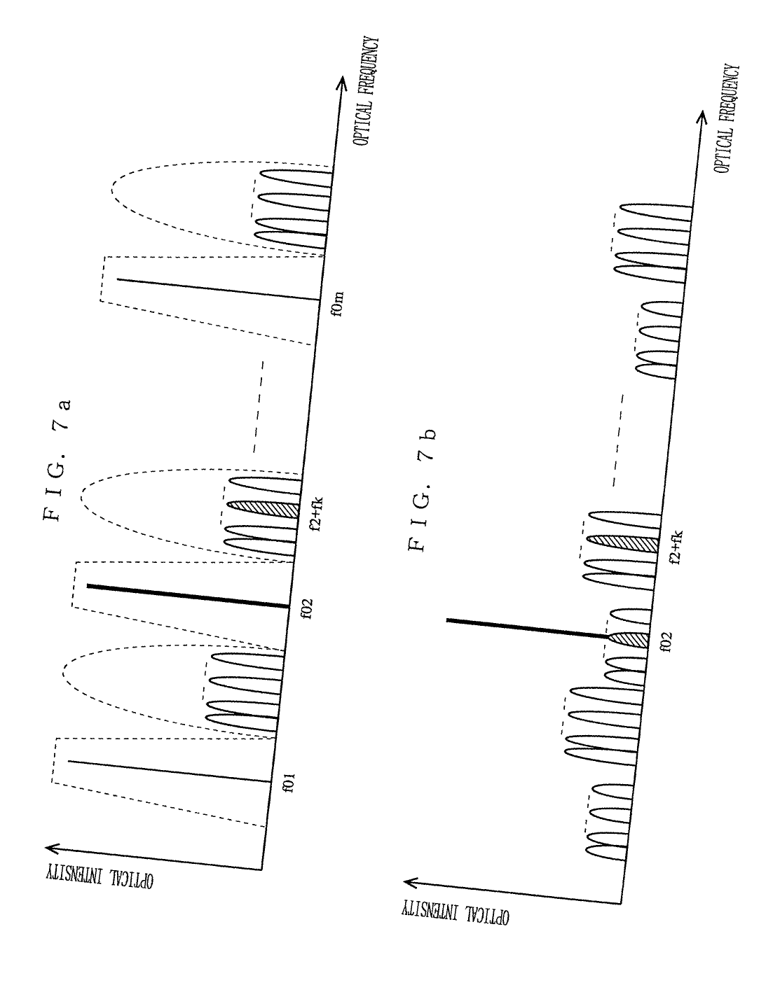

FIG. 7a is an exemplary spectrum of an optical signal at time of coming into the fixed optical filer part 610. Herein, dotted broken lines and curves are each show exemplary transmittance of the periodic fixed optical filter part 610. Specifically, the dotted broken lines each denote transmittance of a periodic fixed optical filter used to extract the group of optical carrier components, while the dotted curves each denote transmittance of a periodic fixed optical filter used to extract a group of optical sideband components. The fixed optical filter part 610 collectively extracts optical carrier components out of m optical signals varied in wavelength from f01 to f0m, and then outputs those to the variable filter 620. As for optical sideband components collectively extracted thereby, the fixed optical filter part 610 outputs those to the second SSB modulation part 360. Thereafter, the variable optical filter 620 selects and extracts any desired optical carrier component out of the received m optical carrier components (here, selected and extracted is presumably the optical carrier component of optical frequency f02, which is denoted by a thick line). On the other hand, the second SSB modulation part 360 collectively subjects, to SSB modulation, those received m optical carrier components by a local oscillation signal whose frequency (here, fk) is equal to the carrier frequency of any one ASK signal carrying the desired digital data.

The optical carrier from the variable optical filter 620 and the resultant optical signal from the second SSB modulation part 360 are combined together in the optical combiner 370. FIG. 7b shows an exemplary spectrum of the resultant optical signal at time of coming out of the optical combiner 370. As shown in FIG. 7b, by SSB modulating the collectively extracted optical sideband components in the second SSB modulation part 360 again this time by the local oscillation signal of frequency fk, a shaded area which denotes an optical component (optical frequency f02+fk) corresponding to the ASK modulated signal of carrier frequency fk is frequency-converted and comes to the position of optical frequency f02. In the spectrum, at the optical frequency f02, the optical carrier component is overlaid on the optical component corresponding to the ASK modulated signal of carrier frequency fk. Therefore, by converting this optical signal by square detection in the optical-electrical conversion part 170 into an electrical signal, the desired digital data can be obtained in the sideband.

Here, the periodic fixed optical filter may be implemented by an optical filter utilizing a Mach-Zehnder interferometer, Fabry-Perot filter, or the like.

Note herein that, the optical carrier components collectively extracted by the fixed optical filter part 610 are provided to the variable optical filter 620, while the optical sideband components to the second SSB modulation part 360. This is not restrictive, and similarly the desired digital data can be derived if the optical carrier components go to the second SSB modulation part 360, while the optical sideband components to the variable optical filter 620. In such case, the second SSB modulation part 360 needs to perform SSB modulation in such manner as to generate the optical sideband components on the same side as in the first SSB modulation parts included in each of the optical transmission parts 311 to 31m. As an example, if the first SSB modulation parts have generated an upper sideband, the second SSB modulation part 360 follows suit.

In this embodiment, any desired optical carrier component is extracted in the variable filter 620 after the fixed optical filter part 610 collectively extracts components of optical carrier and optical sideband. This is not restrictive as long as both of the desired optical carrier and sideband components are shifted onto the same optical frequency under the SSB modulation scheme. As an example, from the optical signal coming from the optical fiber 150, a single variable optical filter may first collectively extract a pair of optical carrier and sideband components of any one optical signal multiplexed thereon, and then a periodic variable filter may separate those from each other.

Similar to the first embodiment, if electrical devices such as the optical-electrical conversion part 170 and an amplifier appropriately provided subsequent thereto are characteristically capable of passing only any low frequency component, the LPF 190 may be omitted.

Also, similar to the first embodiment, the data to be transmitted is not limited to be digital.

As is known from the above, according to the fifth embodiment, there is no need to include any means for selecting any one ASK signal of desired frequency from a frequency division multiplex signal for demodulation as in the fourth embodiment. Also, signals can be allocated over a broader frequency band without requiring an optical-electrical conversion part and any other part connected subsequent thereto to be broadband, and accordingly increasing optical transmission capacity while reducing cost increase. Further, in this embodiment, an optical filter is composed of both a periodic fixed optical filter and a variable optical filter. The periodic fixed optical filter first extracts, from a multiplexed optical signal, two groups of components of optical carrier and optical sideband, and then the variable optical filter extracts only a desired optical carrier component from thus extracted optical carrier components. With such structure, compared with a case using two variable optical filters for extraction, needed herein is only one variable optical filter, which is expensive. Further, the bandwidth for transmission required for the variable optical filter becomes broader, therefore there is no need for any high-performance narrowband variable optical filter. Accordingly, optical transmission capacity is increased while reducing cost increase to a greater degree.

While the invention has been described in detail, the foregoing description is in all aspects illustrative and not restrictive. It is understood that numerous other modifications and variations can be devised without departing from the scope of the invention.

What is claimed is:

1. An optical transmission system transmitting a plurality of electrical signals via an optical transmission path after frequency division multiplexing, said system comprising:
a plurality of amplitude modulation parts for receiving each corresponding transmitting data, and amplitude-modulating carriers of differing frequencies by the transmitting data;
a frequency division multiplex part for receiving a resultant amplitude modulated signal from each of said amplitude modulation parts, and multiplexing said amplitude modulated signals and outputting a frequency division multiplex signal;
an intensity modulation part for intensity modulating an optical signal by said frequency division multiplex signal, and outputting the intensity-modulated optical signal to said optical transmission path;
an external modulation part for intensity modulating said intensity-modulated optical signal this time by an electrical signal equal in frequency to any one of the carriers used in said plurality of amplitude modulation parts; and
an optical-electrical conversion part for converting, by square detection, said optical signal provided by said external modulation part into an electrical signal.

2. The optical transmission system according to claim 1, wherein
said transmitting data includes digital data, and
said plurality of amplitude modulation parts each include a digital amplitude modulation part for subjecting the carriers of differing frequencies to digital amplitude modulation by said digital data.

3. The optical transmission system according to claim 1, further comprising means for extracting, from the electrical signal obtained by conversion in said optical-electrical conversion part, any one transmitting data desired.

4. The optical transmission system according to claim 1, wherein said external modulation part includes a semiconductor optical amplifier.

5. The optical transmission system according to claim 4, wherein
said transmitting data includes digital data, and
said plurality of amplitude modulation part s each include a digital amplitude modulation part for subjecting the carriers of differing frequencies to digital amplitude modulation by said digital data.

6. The optical transmission system according to claim 4, further comprising means for extracting, from the electrical signal obtained by conversion in said optical-electrical conversion part, any one transmitting data desired.

7. An optical transmission system transmitting a plurality of electrical signals via an optical transmission path after frequency division multiplexing, said system comprising:
a plurality of optical transmission parts for each transmitting an optical signal varied in optical frequency;
an optical multiplex part for receiving and multiplexing said optical signals, and outputting a resultant optical signal to said optical transmission path; and
an optical separation part for separating the optical signal coming through said optical transmission path into a plurality of optical signals based on an optical frequency;
for each of said optical signals obtained through separation,
an external modulation part for intensity modulation by an electrical signal of predetermined frequency; and
an optical-electrical conversion part for converting said optical signal provided by said external modulation part, by square detection, into an electrical signal, and
said plurality of optical transmission parts each comprise:
a plurality of amplitude modulation parts for receiving each corresponding transmitting data, and amplitude-modulating carriers of differing frequencies by the transmitting data;
a frequency division multiplex part for receiving a resultant amplitude modulated signal from each of said amplitude modulation parts, and multiplexing said amplitude modulated signals outputting a frequency division multiplex signal; and
an intensity modulation part for intensity modulating an optical signal by said frequency division multiplex signal, and outputting the intensity-modulated optical signal to said optical transmission path.

8. The optical transmission system according to claim 7, wherein
said transmitting data includes digital data, and
said plurality of amplitude modulation parts each include a digital amplitude modulation part for subjecting the carriers of differing frequencies to digital amplitude modulation by said digital data.

9. The optical transmission system according to claim 7, further comprising means for extracting, from the electrical signal obtained by conversion in said optical-electrical conversion part, any one transmitting data desired.

10. An optical transmission system transmitting a plurality of electrical signals via an optical transmission path after frequency division multiplexing, said system comprising:
a plurality of amplitude modulation parts for receiving each corresponding transmitting data, and amplitude-modulating carriers of differing frequencies by the transmitting data;
a frequency division multiplex part for receiving a resultant amplitude modulated signal from each of said amplitude modulation parts, and multiplexing said amplitude modulated signals and outputting a frequency division multiplex signal;
an intensity modulation part for intensity modulating an optical signal by said frequency division multiplex signal, and outputting the intensity-modulated optical signal to said optical transmission path; and
an optical-electrical conversion part for converting, by square detection, said optical signal provided by said external modulation part into an electrical signal, wherein,
superposed on a bias voltage or a bias current of said optical-electrical conversion part is an electrical signal whose frequency is equal to any one of the carriers used in said plurality of amplitude modulation parts.

11. The optical transmission system according to claim 10, wherein
said transmitting data includes digital data, and
said plurality of amplitude modulation parts each include a digital amplitude modulation part for subjecting the carriers of differing frequencies to digital amplitude modulation by said digital data.

12. The optical transmission system according to claim 10, further comprising means for extracting, from the electrical signal obtained by conversion in said optical-electrical conversion part, any one transmitting data desired.

13. An optical transmission system transmitting a plurality of electrical signals via an optical transmission path after frequency division multiplexing, said system comprising:
a plurality of amplitude modulation parts for receiving each corresponding transmitting data, and amplitude-modulating carriers of differing frequencies by the transmitting data;
a frequency division multiplex part for receiving a resultant amplitude modulated signal from each of said amplitude modulation parts, and multiplexing said amplitude modulated signals and outputting a frequency division multiplex signal;
a light source for outputting light constant in intensity;
a first SSB modulation part for SSB (Single SideBand) modulating said light by said frequency division multiplex signal, and outputting a resultant optical signal to said optical transmission path;
an optical filter part for receiving the optical signal coming through said optical transmission path, and from the optical signal, extracting an optical carrier component and an optical sideband component;
a second SSB modulation part for SSB modulating said optical sideband component by an electrical signal whose frequency is equal to any one of the carriers used in said plurality of amplitude modulation parts;
an optical combining part for combining said optical carrier component with a resultant optical signal obtained through SSB modulation in said second SSB modulation part; and
an optical-electrical conversion part for converting, by square detection, a resultant optical signal coming from said optical combining part into an electrical signal.

14. The optical transmission system according to claim 13, wherein
said transmitting data includes digital data, and
said plurality of amplitude modulation parts each include a digital amplitude modulation part for subjecting the carriers of differing frequencies to digital amplitude modulation by said digital data.

15. The optical transmission system according to claim 13, further comprising means for extracting, from the electrical signal obtained by conversion in said optical-electrical conversion part, any one transmitting data desired.

16. An optical transmission system transmitting a plurality of electrical signals via an optical transmission path after frequency division multiplexing, said system comprising:
a plurality of amplitude modulation parts for receiving each corresponding transmitting data, and amplitude-modulating carriers of differing frequencies by the transmitting data;
a frequency division multiplex part for receiving a resultant amplitude modulated signal from each of said amplitude modulation parts, and multiplexing said amplitude modulated signals and outputting a frequency division multiplex signal;
a light source for outputting light constant in intensity;
a first SSB modulation part for SSB modulating said light by said frequency division multiplex signal, and outputting a resultant optical signal to said optical transmission path;
an optical filter part for receiving the optical signal coming through said optical transmission path, and from the optical signal, extracting an optical carrier component and an optical sideband component;
a second SSB modulation part for SSB modulating said optical carrier component by an electrical signal whose frequency is equal to any one of the carriers used in said plurality of amplitude modulation parts;
an optical combining part for combining said optical sideband component with a resultant optical signal obtained through SSB modulation in said second SSB modulation part; and
an optical-electrical conversion part for converting, by square detection, a resultant optical signal coming from said optical combining part into an electrical signal.

17. The optical transmission system according to claim 16, wherein
said transmitting data includes digital data, and
said plurality of amplitude modulation parts each include a digital amplitude modulation part for subjecting the carriers of differing frequencies to digital amplitude modulation by said digital data.

18. The optical transmission system according to claim 16, further comprising means for extracting, from the electrical signal obtained by conversion in said optical-electrical conversion part, any one transmitting data desired.

19. An optical transmission system transmitting a plurality of electrical signals via an optical transmission path after frequency division multiplexing, said system comprising:
a plurality of optical transmission parts for each transmitting an optical signal varied in optical frequency;
an optical multiplex part for receiving and multiplexing said optical signals, and outputting a resultant optical signal to said optical transmission path;
an optical filter part for receiving the optical signal coming through said optical transmission path, and from the optical signal, extracting an optical carrier component and an optical sideband component;
a second SSB modulation part for SSB modulating said optical sideband component by an electrical signal of predetermined frequency;
an optical combining part for combining said optical carrier component with a resultant optical signal obtained through SSB modulation in said second SSB modulation part; and
an optical-electrical conversion part for converting, by square detection, a resultant optical signal coming from said optical combining part into an electrical signal, and
said plurality of optical transmission parts each comprise:
a plurality of amplitude modulation parts for receiving each corresponding transmitting data, and amplitude-modulating carriers of differing frequencies by the transmitting data;
a frequency division multiplex part for receiving a resultant amplitude modulated signal from each of said amplitude modulation parts, and multiplexing said amplitude modulated signals and outputting a frequency division multiplex signal;
a light source for outputting light constant in intensity; and
a first SSB modulation part for SSB modulating said light by said frequency division multiplex signal.

20. The optical transmission system according to claim 19, wherein
said transmitting data includes digital data, and
said plurality of amplitude modulation parts each include a digital amplitude modulation part for subjecting the carriers of differing frequencies to digital amplitude modulation by said digital data.

21. The optical transmission system according to claim 19, further comprising means for extracting, from the electrical signal obtained by conversion in said optical-electrical conversion part, any one transmitting data desired.

22. The optical transmission system according to claim 19, wherein said optical filter part comprises an optical filter which shows periodicity to wavelength, and a variable wavelength filter which passes only light of desired wavelength and can be varied in band for passing.

23. The optical transmission system according to claim 22, wherein
said transmitting data includes digital data, and
said plurality of amplitude modulation parts each include a digital amplitude modulation part for subjecting the carriers of differing frequencies to digital amplitude modulation by said digital data.

24. The optical transmission system according to claim 22, further comprising means for extracting, from the electrical signal obtained by conversion in said optical-electrical conversion part, any one transmitting data desired.

25. An optical transmission system transmitting a plurality of electrical signals via an optical transmission path after frequency division multiplexing, said system comprising:
a plurality of optical transmission parts for each transmitting an optical signal varied in optical frequency;
an optical multiplex part for receiving and multiplexing said optical signals, and outputting a resultant optical signal to said optical transmission path;
an optical filter part for receiving the optical signal coming through said optical transmission path, and from the optical signal, extracting an optical carrier component and an optical sideband component;
a second SSB modulation part for SSB modulating said optical carrier component by an electrical signal of predetermined frequency;
an optical combining part for combining said optical sideband component with a resultant optical signal obtained through SSB modulation in said second SSB modulation part; and
an optical-electrical conversion part for converting, by square detection, a resultant optical signal coming from said optical combining part into an electrical signal, and
said plurality of optical transmission parts each comprise:
a plurality of amplitude modulation parts for receiving each corresponding transmitting data, and amplitude-modulating carriers of differing frequencies by the transmitting data;
a frequency division multiplex part for receiving a resultant amplitude modulated signal from each of said amplitude modulation parts, and multiplexing said amplitude modulated signals and outputting a frequency division multiplex signal;
a light source for outputting light constant in intensity; and
a first SSB modulation part for SSB modulating said light by said frequency division multiplex signal.

26. The optical transmission system according to claim 25, wherein
said transmitting data includes digital data, and
said plurality of amplitude modulation parts each include a digital amplitude modulation part for subjecting the carriers of differing frequencies to digital amplitude modulation by said digital data.

27. The optical transmission system according to claim 25, further comprising means for extracting, from the electrical signal obtained by conversion in said optical-electrical conversion part, any one transmitting data desired.

28. The optical transmission system according to claim 25, wherein said optical filter part comprises an optical filter which shows periodicity to wavelength, and a variable wavelength filter which passes only light of desired wavelength and can be varied in band for passing.

29. The optical transmission system according to claim 28, wherein
said transmitting data includes digital data, and
said plurality of amplitude modulation parts each include a digital amplitude modulation part for subjecting the carriers of differing frequencies to digital amplitude modulation by said digital data.

30. The optical transmission system according to claim 28, further comprising means for extracting, from the electrical signal obtained by conversion in said optical-electrical conversion part, any one transmitting data desired.

31. An optical receiver for reproducing any desired electrical signal from an optical signal intensity modulated by a frequency division multiplex signal having a plurality of amplitude-modulated electrical signals multiplexed thereon, said receiver comprising:
an external modulation part for intensity modulating said optical signal by an electrical signal of predetermined electrical signal; and
an optical-electrical conversion part for converting, by square detection, said optical signal provided by said external modulation part into an electrical signal.

32. An optical receiver for reproducing any desired electrical signal from an optical signal intensity modulated by a frequency division multiplex signal having a plurality of amplitude-modulated electrical signals multiplexed thereon, said receiver comprising:
a local oscillation signal source for outputting an electrical signal of a predetermined frequency; and
an optical-electrical conversion part for converting said optical signal into an electrical signal by square detection, wherein
superposed on a bias voltage or a bias current of said optical-electrical conversion part is the electrical signal from said local oscillation signal source.

33. An optical receiver for reproducing any desired electrical signal from an optical signal SSB (Single SideBand) modulated by a frequency division multiplex signal having a plurality of amplitude-modulated electrical signal multiplexed thereon, said receiver comprising:
an optical filter part for extracting an optical carrier component and an optical sideband component from said optical signal;
an SSB modulation part for SSB modulating said optical sideband component by an electrical signal of predetermined frequency;
an optical combining part for combining said optical carrier component with a resultant optical signal SSB modulated by said SSB modulation part; and
an optical-electrical conversion part for converting, by square detection, said SSB-modulated optical signal into an electrical signal.

34. An optical receiver for reproducing any desired electrical signal from an optical signal SSB (Single SideBand) modulated by a frequency division multiplex signal having a plurality of amplitude-modulated electrical signal multiplexed thereon, said receiver comprising:
an optical filter part for extracting an optical carrier component and an optical sideband component from said optical signal;
an SSB modulation part for SSB modulating said optical carrier component by an electrical signal of predetermined frequency;
an optical combining part for combining said optical sideband component with a resultant optical signal SSB modulated by said SSB modulation part; and
an optical-electrical conversion part for converting, by square detection, said SSB-modulated optical signal into an electrical signal.

35. An optical receiver for reproducing any desired electrical signal from a multiplexed optical signal which is structured by a plurality of optical signals SSB (Single SideBand) modulated by a frequency division multiplex signal having a plurality of amplitude-modulated electrical signal multiplexed thereon, said receiver comprising:
an optical filter part for extracting, from said multiplexed optical signal, an optical carrier component and an optical sideband component of one of said plurality of optical signals;
an SSB modulation part for SSB modulating said optical sideband component by an electrical signal of predetermined frequency;
an optical combining part for combining said optical carrier component with a resultant optical signal SSB modulated by said SSB modulation part; and
an optical-electrical conversion part for converting, by square detection, said SSB-modulated optical signal into an electrical signal.

36. The optical receiver according to claim 35, wherein said optical filter part comprises an optical filter which shows periodicity to wavelength, and a variable wavelength filter which passes only light of desired wavelength and can be varied in band for passing.

37. An optical receiver for reproducing any desired electrical signal from a multiplexed optical signal which is structured by a plurality of optical signals SSB (Single SideBand) modulated by a frequency division multiplex signal having a plurality of amplitude-modulated electrical signal multiplexed thereon, said receiver comprising:
an optical filter part for extracting, from said multiplexed optical signal, an optical carrier component and an optical sideband component of one of said plurality of optical signals;
an SSB modulation part for SSB modulating said optical carrier component by an electrical signal of predetermined frequency;
an optical combining part for combining said optical sideband component with a resultant optical signal SSB modulated by said SSB modulation part; and
an optical-electrical conversion part for converting, by square detection, said SSB-modulated optical signal into an electrical signal.

38. The optical receiver according to claim 37, wherein said optical filter part comprises an optical filter which shows periodicity to wavelength, and a variable wavelength filter which passes only light of desired wavelength and can be varied in band for passing.
